(19) United States
(12) Patent Application Publication
(10) Pub. No.: US 2004/0231216 A1
(43) Pub. Date: Nov. 25, 2004

(54) Airline ticket/boarding pass/identification organizer and method for use thereof

(76) Inventor: Steven W. Lundberg, Edina, MN (US)

Correspondence Address: Schwegman, Lundberg, Woessner & Kluth, P.A., P.O. Box 2938, Minneapolis, MN, 55402, US

(21) Appl. No.: 10/781,954

(22) Filed: Feb. 19, 2004

Related U.S. Application Data
(60) Provisional application No. 60/448,333, filed on Feb. 19, 2003.
(60) Provisional application No. 60/453,109, filed on Mar. 7, 2003.

(51) Int. Cl. G09F 21/02

(52) U.S. Cl. 40/661; 40/586

(57) ABSTRACT

The present invention includes as organizer, comprising a main body comprising a first compartment and a second compartment, wherein the first compartment is sized to receive an airline ticket or boarding pass and the second compartment is sized to receive an identification card, the first compartment and second compartment each having a transparent window for displaying indicia on the airline ticket or boarding pass and identification card.

### RELATED APPLICATIONS

This application claims priority from U.S. Provisional Patent Application No. 60/448,333, filed Feb. 19, 2003 and U.S. Provisional Patent Application No. 60/453,109, filed Mar. 7, 2003, which applications are incorporated herein by reference.

### TECHNICAL FIELD OF THE INVENTION

This invention pertains generally to airline travel, and more particularly to organizing and carrying airline tickets, boarding passes and identification.

### BACKGROUND OF THE INVENTION

Airline security has been tightened dramatically in response to terrorist activity in the United States and elsewhere. As a result, it is now necessary for the average traveler to present tickets and/or boarding passes and a picture identification at multiple checkpoints. This requirement would present relatively little difficulty if that were all the traveler had to worry about. In addition, however, most travelers have their hands full with luggage or other items, making it particularly cumbersome to present tickets and/or boarding passes and ID while lugging the rest of their gear. The result is a lot of fumbling around for passengers and delays due to passengers hunting or digging around in pockets and purses for the required tickets and/or boarding passes and identification.

### SUMMARY

The present invention includes an organizer, comprising a main body comprising a first compartment and a second compartment, wherein the first compartment is sized to receive an airline ticket or boarding pass and the second compartment is sized to receive an identification card, the first compartment and second compartment each having a transparent window for displaying indicia on the airline ticket or boarding pass and identification card.

### BRIEF DESCRIPTION OF THE DRAWINGS

FIG. 1 is a top plan view of one embodiment of the organizer of the present invention, without identification information.

FIG. 2 is a top plan front view of the organizer of FIG. 1, containing a boarding pass and, having identification information concealed by a flap.

FIG. 3 is a top plan front view of the organizer of FIG. 1, containing the boarding pass of FIG. 2, wherein the flap in a position that reveals identification information.

FIG. 4 is a top plant front view of an organizer, containing a boarding pass and a driver's license.

FIG. 5 is a top plant view of an organizer, containing a boarding pass and a driver's license, in an open position.

FIG. 6 is a top plan view of the organizer of FIG. 5, in a closed position.

FIG. 7 is a flow chart of a method of using a holder.

FIG. 8 is a flow chart of a method of using a holder.

### DETAILED DESCRIPTION OF THE INVENTION

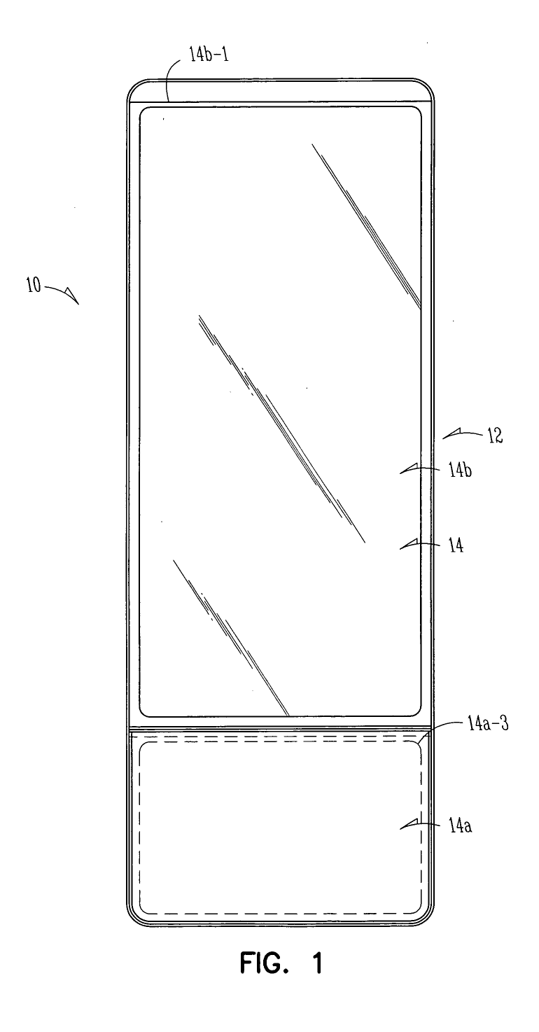

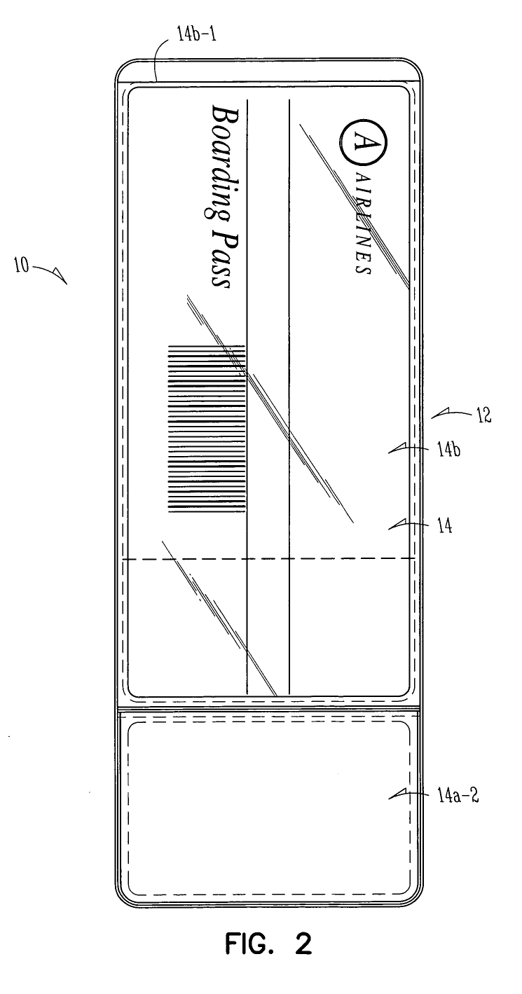

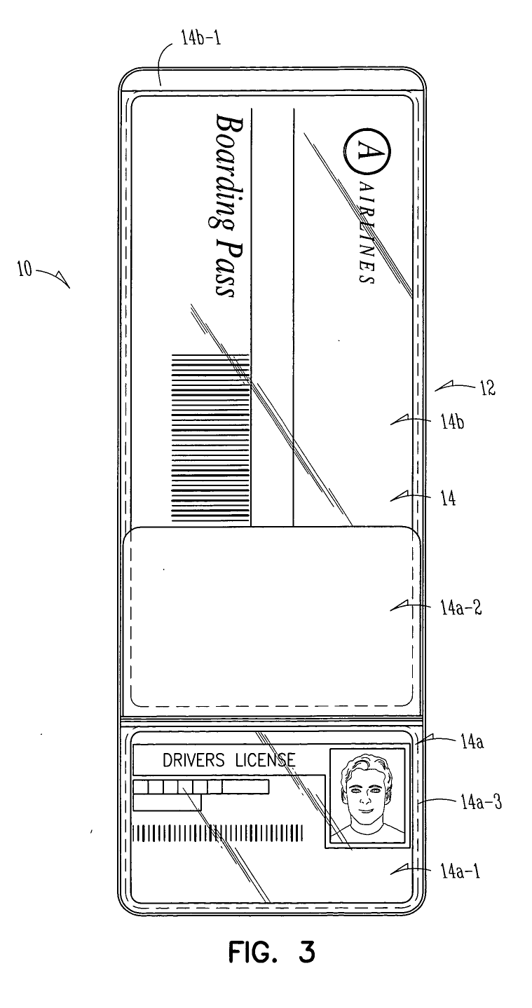

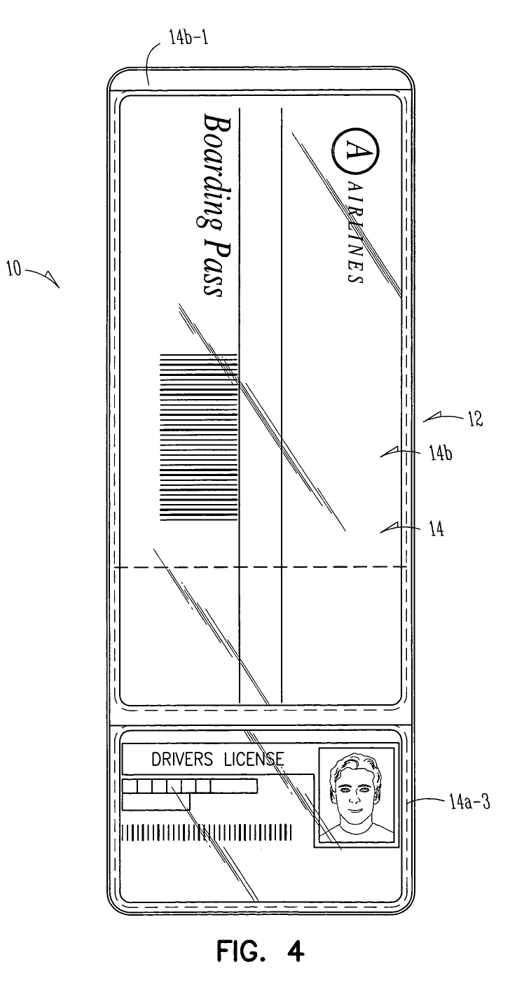

Referring now to FIG. 1, there is illustrated an organizer 10 according to a first embodiment of the invention. Organizer 10 includes a first portion 12 with one or more compartments 14 used to hold a traveler's identification 16 and airline tickets and/or boarding passes 18. According to embodiment 10, a first pocket or compartment 14a is provided with a transparent wall 14a-1 and is sized to hold a driver's license or equivalent sized identification card. Compartment 14a is thus approximately 84 millimeters in length and 53 millimeters wide. A flap 14a-2 is provided to cover the transparent wall 14a-1 so that any identification held in the compartment 14a is kept private until the flap is lifted. The flap is optionally secured to the wall 14a-1 with a fastener such as Velcro or a snap or other fastening mechanism known to those skilled in the art. In the embodiment shown, the compartment 14a is accessible from a slit or opening 14a-3 in the top or side of the compartment, which allows the passenger to insert and remove the identification and also allows security personnel to remove the identification easily for closer inspection. The opening 14a-3 may be sealed shut with a Velcro system or with a zipper or snap system or any other suitable system. In one embodiment, the zipper or snap is made of a non-metallic material.

Organizer 10 further includes a pocket or compartment 14b that is sized to hold an airline ticket or boarding pass, and accordingly, in one embodiment, has a length of about 23 mm and a width of about 84 mm. Compartment 14b is constructed to allow the ticket or boarding pass to be inserted in the compartment 14b from a top opening 14b-1, so it does not fall out easily but also so it can be readily retrieved by the passenger or someone at a security check point or upon boarding of the plane. The compartment 14b is secured in a manner that prevents the ticket or boarding pass to fall out of the compartment. A securing mechanism such as Velcro, or a zipper is usable to secure the compartment 14b. According to another embodiment, a further pocket or slot is provided into which a torn off boarding pass stub can be inserted.

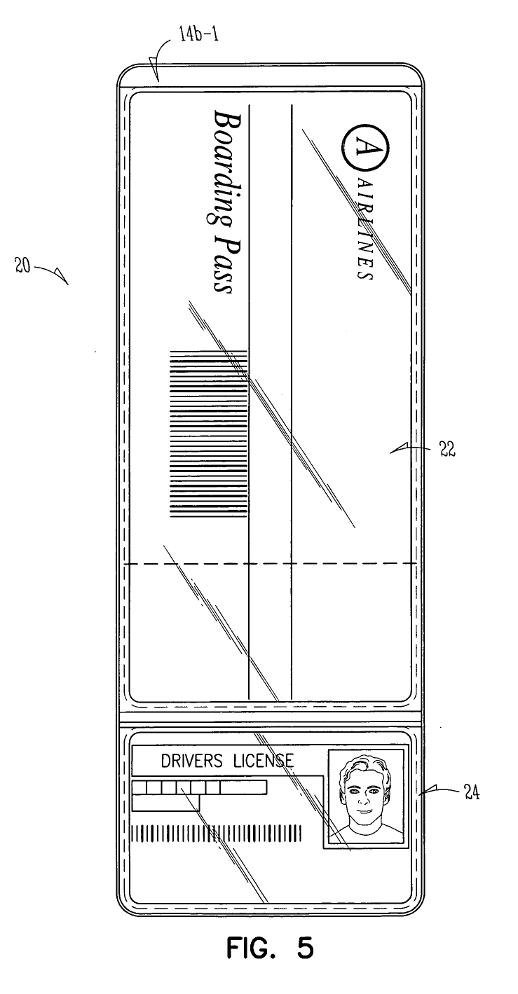

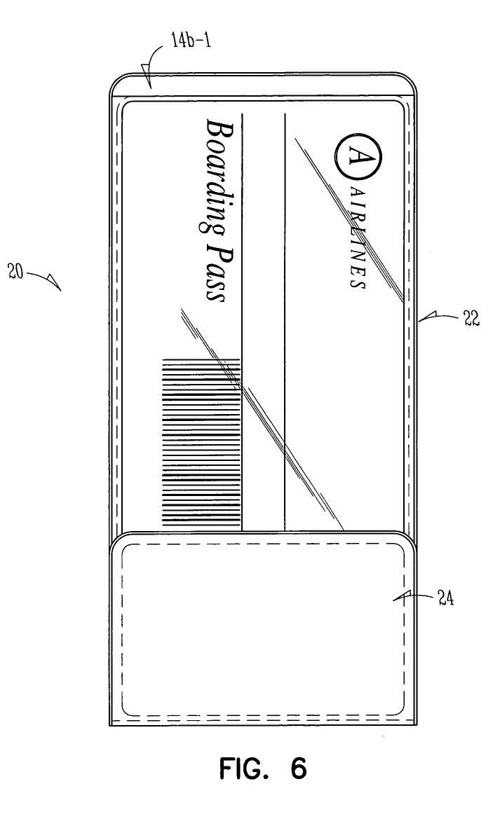

In another organizer embodiment, illustrated at 20 in FIG. 5, the organizer 20 includes a ticket/boarding pass compartment 22 and a picture identification compartment, such as a driver's license compartment 24. The compartment 24 for picture identification is obscured by folding the compartment 24 onto the compartment 22, as shown in FIG. 6. The compartment 24 is secured to the compartment 22 by a conventional mechanism such as Velcro and one or more snaps.

In one embodiment, the organizer further includes a strap or string that enables a user the put the organizer with the strap or string around his or her neck.

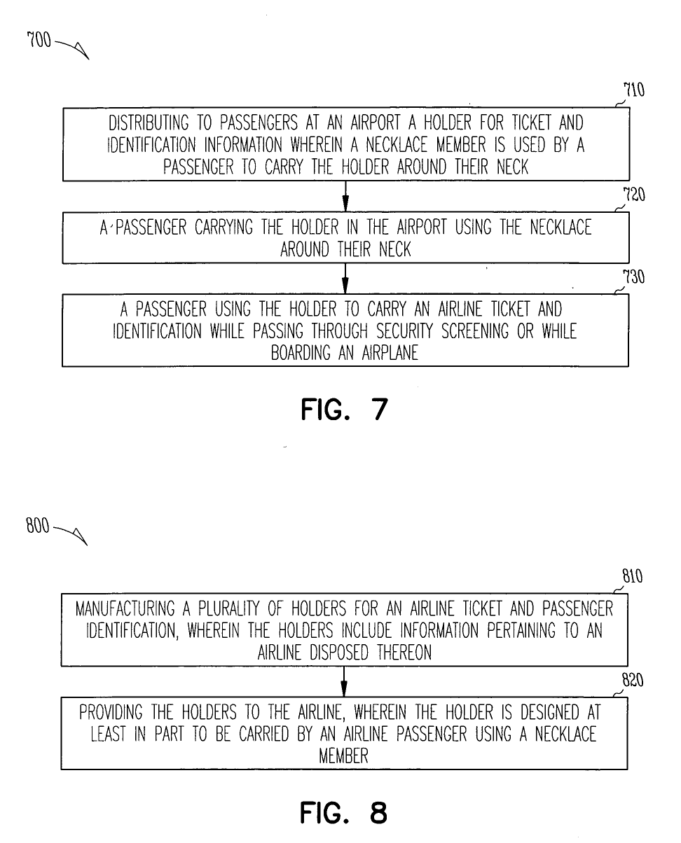

FIG. 7 is an exemplary embodiment of a method 700 for utilizing a holder for a ticket and identification information. In such an embodiment, the method includes distributing 710 to passengers at an airport a holder for ticket and identification information, wherein a necklace member is used by a passenger to carry the holder around their neck. Method 700 further includes a passenger carrying 720 the holder in the airport using the necklace around their neck and a passenger using 730 the holder to carry an airline ticket and identification while passing through security screening or while boarding an airplane. In one such embodiment of method 700, distributing 710 includes giving the holder away as a promotion. Another such embodiment of method 700 includes distributing 710 includes selling the holder to passengers.

Some further embodiments of method 700 include a passenger using the holder to provide airport personnel access to the passenger's ticket and identification. One such embodiment is configured to allow airport personnel to readily remove one or both of a passenger's ticket and identification for inspection.

In another exemplary embodiment of method 700 using 730 the holder to carry an airline ticket and identification while passing through security screening includes configuring the holder to allow airport personnel to view a passenger ticket and/or a passenger identification while the ticket and identification are in the holder.

Some embodiments of method 400 include constructing a holder for performing the method wherein the holder and necklace are constructed of substantially non-metallic materials so as to not trigger an alarm in an airport security screening system. In some such embodiments of method 700, the holder is disposable after one or more uses.

Another embodiment of method 700 includes distributing 710 a holder having information concerning airline security or airport security information embossed thereon. In some such embodiments, the information concerning airline security or airport security comprises rules or procedures.

Yet another embodiment of method 700, wherein distributing 710 a holder includes providing the passenger the holder and necklace separately with the necklace fastened to the holder after the passenger takes the holder. Other embodiments include the necklace already attached to the holder. Some such embodiments include distributing 710 a necklace with advertising information on the necklace. Some other embodiments include distributing the holder with airline information or advertising material on or in the holder. In some such embodiments, the airline information includes an airline logo or name.

As shown in method 800 in FIG. 8, another embodiment includes manufacturing 810 a plurality of holders for an airline ticket and passenger identification, wherein the holders include information pertaining to an airline disposed thereon, and providing 820 the holders to the airline, wherein the holder is designed at least in part to be carried by an airline passenger using a necklace member.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

What is claimed is:

1. A method comprising:
distributing to passengers at an airport a holder for ticket and identification information;
wherein a necklace member is used by a passenger to carry the holder around their neck;
a passenger carrying the holder in the airport using the necklace around their neck; and
a passenger using the holder to carry an airline ticket and identification while passing through security screening or while boarding an airplane.

2. A method according to claim 1 further including the passenger using the holder to provide airport personnel access to the passenger's ticket and identification.

3. A method according to claim 1 further wherein the holder is configured to allow airport personnel to readily remove a passenger ticket for inspection.

4. A method according to claim 1 further wherein the holder is configured to allow airport personnel to readily remove a passenger identification for inspection.

5. A method according to claim 1 further wherein the folder is configured to allow airport personnel to view a passenger ticket while it is in the holder.

6. A method according to claim 1 further wherein the folder is configured to allow airport personnel to view a passenger identification while it is in the holder.

7. A method according to claim 1 further wherein the holder and necklace are constructed of substantially non-metallic materials so as to not trigger an alarm in an airport security screening system.

8. A method according to claim 1 further wherein the holder is disposable.

9. A method according to claim 1 further including the passenger disposing of the holder after it has been used once.

10. A method according to claim 1 further including the holder having information concerning airline security or airport security information embossed thereon.

11. A method according to claim 10 further wherein the information comprises rules or procedures.

12. A method according to claim 1 further including providing the passenger the holder and necklace separately with the necklace fastened to the holder after the passenger takes the holder.

13. A method according to claim 1 further wherein the holder and necklace are fastened to each other prior to being distributed to a passenger.

14. A method according to claim 1 further wherein the holder includes airline information embossed thereon.

15. A method according to claim 14 further wherein the airline information is an airline name or logo.

16. A method comprising:
manufacturing a plurality of holders for an airline ticket and passenger identification, wherein the holders include information pertaining to an airline disposed thereon;
providing the holders to the airline; and
wherein the holder is designed at least in part to be carried by an airline passenger using a necklace member.

17. A method according to claim 16 including:
a passenger carrying the holder in the airport using the necklace around their necks; and
a passenger using the holder to carry an airline ticket and identification while passing through security screening or while boarding an airplane.

18. A method according to claim 16 further including the passenger using the holder to provide airport personnel access to the passenger's ticket and identification.

19. A method according to claim 16 further wherein the holder is configured to allow airport personnel to readily remove a passenger ticket for inspection.

20. A method according to claim 16 further wherein the holder is configured to allow airport personnel to readily remove a passenger identification for inspection.

21. A method according to claim 16 further wherein the folder is configured to allow airport personnel to view a passenger ticket while it is in the holder.

22. A method according to claim 16 further wherein the folder is configured to allow airport personnel to view a passenger identification while it is in the holder.

23. A method according to claim 16 further wherein the holder and necklace are constructed of substantially non-metallic materials so as to not trigger an alarm in an airport security screening system.

24. A method according to claim 16 further wherein the holder is disposable.

25. A method according to claim 16 further including the passenger disposing of the holder after it has been used once.

26. A method according to claim 16 further including the holder having information concerning airline security or airport security information embossed thereon.

27. A method according to claim 23 further wherein the information comprises rules or procedures.

28. A method according to claim 16 further including providing the passenger the holder and necklace separately with the necklace fastened to the holder after the passenger takes the holder.

29. A method according to claim 16 further wherein the holder and necklace are fastened to each other prior to being distributed to a passenger.

30. A method according to claim 16 further wherein the holder includes airline information embossed thereon.

31. A method according to claim 30 further wherein the airline information is an airline name or logo.

32. A method comprising:
manufacturing a plurality of holders for an airline ticket and passenger identification;
providing the holders to airport personnel; and
wherein the holder is designed at least in part to be carried by an airline passenger using a necklace member.

33. A method according to claim 32 including:
a passenger carrying the holder in the airport using the necklace around their necks; and
a passenger using the holder to carry an airline ticket and identification while passing through security screening or while boarding an airplane.

34. A method according to claim 32 further including the passenger using the holder to provide airport personnel access to the passenger's ticket and identification.

35. A method according to claim 32 further wherein the holder is configured to allow airport personnel to readily remove a passenger ticket for inspection.

36. A method according to claim 32 further wherein the holder is configured to allow airport personnel to readily remove a passenger identification for inspection.

37. A method according to claim 32 further wherein the folder is configured to allow airport personnel to view a passenger ticket while it is in the holder.

38. A method according to claim 32 further wherein the folder is configured to allow airport personnel to view a passenger identification while it is in the holder.

39. A method according to claim 32 further wherein the holder and necklace are constructed of substantially non-metallic materials so as to not trigger an alarm in an airport security screening system.

40. A method according to claim 32 further wherein the holder is disposable.

41. A method according to claim 32 further including the passenger disposing of the holder after it has been used once.

42. A method according to claim 32 further including the holder having information concerning airline security or airport security information embossed thereon.

43. A method according to claim 42 further wherein the information comprises rules or procedures.

44. A method according to claim 32 further including providing the passenger the holder and necklace separately with the necklace fastened to the holder after the passenger takes the holder.

45. A method according to claim 32 further wherein the holder and necklace are fastened to each other prior to being distributed to a passenger.

46. A method according to claim 32 further wherein the holder includes airline information embossed thereon.

47. A method according to claim 32 further wherein the airline information is an airline name or logo.

48. A method of advertising comprising:
distributing a holder for carrying materials commonly required for passing through airport security, wherein the holder has advertising material printed thereon.

49. An organizer, comprising:
a main body comprising a first compartment and a second compartment wherein the first compartment is sized to receive an airline ticket or boarding pass and the second compartment is sized to receive an identification card, the first compartment and second compartment each having a window for displaying indicia on the airline ticket or boarding pass and identification card.

50. The organizer of claim 49, wherein the first compartment has a long side and a short side, wherein an opening for receiving the airline ticket or boarding pass is defined at the short side.

51. The organizer of claim 49, further comprising a flap for covering indicia displayed on the identification card through the transparent window wherein the flap has a first position that displays indicia on the identification card and a second position that conceals indicia on the identification card.

52. The organizer of claim 49, wherein the second compartment is foldable onto the first compartment, thereby concealing indicia on the identification card.

53. The organizer of claim 49, further comprising a means that enables a user to put the organizer around his or her neck.

54. The organizer of claim 49, further comprising a third compartment or slot for receipt of a boarding pass stub.
